(19) United States
(12) Patent Application Publication
(10) Pub. No.: US 2003/0201561 A1
(43) Pub. Date: Oct. 30, 2003

(54) Heating and particulate drawing process and assembly for aggregating plasticized granules in adhering fashion to an exposed face of a heated tool or part

(76) Inventor: Miguel A. Linares, Bloomfield Hills, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/413,886

(22) Filed: Apr. 15, 2003

Related U.S. Application Data
(60) Provisional application No. 60/413,139, filed on Sep. 25, 2002.
(60) Provisional application No. 60/374,771, filed on Apr. 24, 2002.

(51) Int. Cl. B29C 41/38; B29C 41/02

(52) U.S. Cl. 264/69; 264/109; 264/338; 427/133; 425/429; 249/115

(57) ABSTRACT

An apparatus and related method for forming a three dimensional polymer based part including a die tool having a specified shape and size and exhibiting an exposed polymer adhering surface corresponding in configuration to a polymeric based part to be created. A bin is filled with a polymer material in particulate form and, upon positioning the die tool overhead, the die tool is inserted into the bin, such as by either lowering the tool or raising the bin. The tool is positioned within the bin such that the exposed and adhering surface is in contact with the particulate material. Heat is applied to either or both the die tool and the bin particulate and, in combination with an optional vibrating motion imparted to the bin, causes a specified volume of polymer material to adhere and to form upon the exposed surface of the die tool.

### CROSS REFERENCE TO RELATED APPLICATIONS

The present invention claims the priority of U.S. Provisional Application Serial No. 60/374,771 filed Apr. 24, 2002, and entitled Description of Plastic Stamping Process Details for Run Off and Holes of Part, as well as U.S. Provisional Application Serial No. 60/413,139, filed Sep. 25, 2002, and entitled Heated and Particulate Drawing Process.

### BACKGROUND OF THE INVENTION

1. Field of the Invention

The present invention relates generally to apparatuses and methods for aggregating a plasticized resin or composite in a drawing process and through the application of heat. More particularly, the present invention discloses a drawing process and assembly for creating a plasticized part, using a heated die surface lowerable into a bin of resinous material in pellet or aggregate form, as well as a related process for coating a heated structural steel member drawn in continuous fashion through a like bin of resinous material.

2. Description of the Prior Art

The prior art is well documented with various examples of article forming assemblies and methods and which in particular incorporate the use of heated and/or compression technology and in which to form a three dimensional resin based article. The objective in each instance is to create a plasticized/resinous based article in a desired time and cost efficient basis.

General examples drawn from the prior art include U.S. Pat. No. 5,073,329, issued from Carrara, and which teaches an apparatus and method for forming seals, such as composite seals in rubber/meta or other materials, and which includes supplying a raw elastomeric mixture in the form of a suitably shaped extrusion. A transfer machine with a plurality of carriers is provided, each having hinged mold halves defining a mold cavity therebetween, a volume of a blank of raw elastomeric material being deposited on a first and opened mold half. The mold halves are closed and the blank of raw material both compressed and heated to form the desired finished product and as is defined by the specified mold cavity.

U.S. Pat. No. 3,600,753, issued to Otto, teaches a differential pressure forming mold wherein a sheet of deformable plastic is supported between a mold assembly having a plurality of article forming mold cavities and an opposed mold assembly having a plurality of cavity aligned, projecting plug assists. A plate is incorporated within the mold assembly, having the plug assists, and is operative to prevent ballooning of portions of the sheet surrounding those portions which are moved into the mold cavities by the plug assists and is mounted for relative movement with the plug assists. The plate is moved toward the mold assembly having the mold cavities to clamp the edges of the plastic sheet thereto, prior to the time the plug assists are moved into the cavities to stretch the sheet and mechanically move portions of the sheet into the mold cavities. Thereafter, a differential pressure condition is created to move the sheet portions finally into intimate engagement with the mold cavities.

U.S. Pat. No. 5,118,380, issued to Gatarz et al., teaches a rim flexible manufacturing insert for a molding press having an upper movable platen adapted to support a male mold member and a fixed lower platen adapted to support a female mold member. The molding press includes a mix head system and a hydraulic ejector system supported below the fixed lower platen. The manufacturing insert includes a table having a platen surface with legs depending downwardly therefrom, the legs being removably securable to the fixed lower platen of the molding press. The platen surface includes an enlarged opening therethrough and a mix head support system is supported below the platen surface intermediate the legs of the table. The mix head support system includes a mix head support and a slide system for permitting three dimensional movement of the mix head from a first position where the mix head extends through the enlarged opening in the platen surface and to a second position where the mix head is beyond the upper platen.

U.S. Pat. No. 5,617,631, issued to Nguyen, teaches a method of making a liquid ink printhead orifice plate which includes the ink carrying features and a flat mandrel. Once the orifice plate has been stamped, excess material is removed from the orifice plate to reveal ink carrying features of the stamped orifice plate. The orifice plate mandrel is formed by electroforming a mandrel on an etched silicon wafer which defines a plurality of ink carrying channels and ink reservoirs. The electroform mandrel can be made of any number of metal which includes nickel.

Finally, U.S. Pat. No. 6,318,988, issued to Wrobbel, teaches a tool which enables articles to be deep-drawn without difficulty, even when the material used is of low elasticity and/or when a decorative sheet is used to produce a composite article. The tool includes a die which has a recessed zone which extends between a die opening and die contour or an undercut. The recessed zone is delimited on one side at right angles to an end of the die and, in order to hold a decorative sheet in place, a mounting is fitted on a part of the recessed zone facing the end of the die.

### SUMMARY OF THE PRESENT INVENTION

The present invention discloses an apparatus and method for forming a three dimensional and polymer based part. The apparatus includes including a die tool having a specified shape and size and exhibiting an exposed polymer adhering surface corresponding in configuration to a polymeric based part to be created. A bin is filled with a polymer material, typically a synthetic plastic or the like, in particulate form and, upon positioning the die tool overhead, the die tool is inserted into the bin, such as by either lowering the tool or, in the preferred disclosed embodiment, by raising the bin.

The tool is positioned within the bin such that the exposed and adhering surface is in contact with the particulate material. Heat is applied to either or both the die tool and the bin aggregate and, in combination with an optional vibrating motion imparted to the bin, causes a specified volume of polymer material to adhere and to form upon the exposed surface of the die tool over a predetermined time period.

In one preferred embodiment, each of a plurality of individual die tools are supported in suspended fashion from a conveyor and, in successive fashion, are contacted with the particulate material in the bin and withdrawn after the specified period of time. The plastic (thermoplastic) part formed upon the die tool is capable of being removed, such as by peeling off, when in the green or thermo-reacting stage and during which it is still flexible and easy to bend.

In a further preferred embodiment, the die tool is substituted by an elongated and structural member, typically a steel beam or reinforcing rod, and which is translated in axially extending fashion through a suitably constructed and configured bin of particulate filled material. Heat is again applied, typically to the beam, rod, etc., and prior to it being translated through the aggregate filled bin and the desired volume of particulate material adhered to the surface of the beam or rod. In this manner, the surface of the structural steel member is coated with a rust-inhibiting material.

Also disclosed is a method of forming a three dimensional polymer coating upon a die tool, the tool having a specified shape and size and exhibiting an exposed polymer adhering surface corresponding in configuration to a polymeric based part to be created. The method steps include filling a bin with a polymer material in particulate form, heating the die tool to a specified temperature, inserting the die tool into the bin and such that the polymer adhering surface is in contact with the particulate material, and withdrawing the die tool from the bin upon a desired volume of the polymer material adhering to the exposed surface.

Additional steps include applying a ceramic coating about an extending perimeter of the adhering surface of the tool and/or about at least one aperture defined in the die tool. Other steps again include vibrating the bin in an elevated position, within which is contained the specified die tool, and of peeling off the semi-molten polymer material following the withdrawing of the tool from the bin.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a die tool upon which is adhered a three dimensional volume of a resinous particulate according to a preferred embodiment of the present invention;

FIG. 2 is a side view of the die tool, substantially as illustrated in FIG. 1, mounted between ceramic insulation portions and in order to define a particulate adhering surface according to the present invention;

FIG. 3 is an enlarged view of a portion of the die tool and adjoining insulating portion according to the present invention and further showing an insulating plug covering an aperture formed in the adhering die tool surface;

FIG. 4 is an illustration of the die tool and ceramic surround portions, as substantially shown in FIG. 2, and further illustrating a first pre-inserting position of the die tool into a bin of polymerized particulate according to the present invention;

FIG. 5 is an illustration of an inserted and vibrating position of the die tool within the aggregate bin and by which a volume of particulate is caused to adhere to the exposed surfaces of the die tool according to the present invention;

FIG. 6 is a further side view illustration of a withdrawn position of the die tool and further showing a release position of the formed and particulate material from the die tool according to the present invention; and

FIG. 7 is an illustration of an alternate process according to the present invention for coating a heated structural steel member drawn in continuous fashion through a bin of resinous material.

### DETAILED DESCRIPTION OF THE PREFERRED EMBODIMENTS

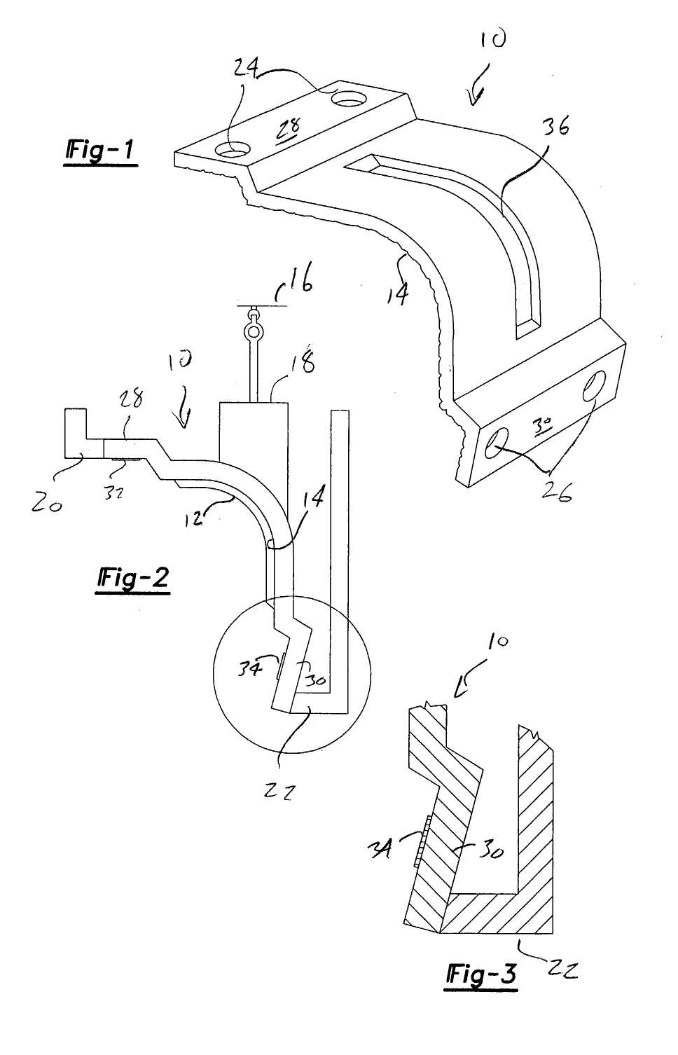

Referring now to the drawing figures, and in particular to FIGS. 1 and 2, a die tool is generally illustrated at 10 according to a first preferred embodiment of the present invention and upon which a polymer or plasticized three dimensional part is formed. An exposed surface 12 is illustrated forming a portion of an underside (typically polished and attracting) surface 14 of the die tool 10.

The surfaces 12 and 14 are understood to provide a negative recess for the creation of a three dimensionally constructed article including at least one high quality surface, this corresponding to the built-up surface of the part. A preferred application of the built-up part to be created is for use in creating a suitable plastic/resin based automobile part such as a wheel liner (generally understood to correspond to the part to be created from the negative die surfaces 12 and 14 illustrated herein), door panel, and interior plastic part (panel, liner, bumper, etc.).

The plasticized or polymeric article thus created can include such other applications as a plastic shingle, for homes, plastic siding, shower units, Jacuzzi units, swimming pool parts, and hollow panels filled with different materials used in such as third world housing constructions. Other and additional uses of the three-dimensional parts thus created may include, without limitation, such as those as for use in recreation land and sea vehicles.

Referring again to FIG. 1, the die tool 10 may be constructed of a suitable metallic (such as steel, aluminum or the like) material and include any specified configuration and by which the polymer attracting surface 14 associated therewith corresponds to the desired three dimensional part to be created. As best illustrated in FIG. 2, a conveyor mechanism 16 and attachment 18 may be incorporated to support, in plural and spaced apart fashion, each of a plurality of the die tools 10.

Insulating and non-polymer adhering portions, such as a ceramic coated material, are indicated at 20 and 22 in FIG. 2 and are understood to secure to the die tool 10 in order to encircle a periphery of the polymeric attracting surface 14. As also shown in FIG. 1, pairs of apertures are illustrated at 24 and 26, in corresponding fashion to opposite ends 28 and 30, respectively, of the die tool 10. The apertures are intended to define corresponding apertures in the three dimensional part to be created and, viewing again FIG. 2, insulating coatings (or patches), see at 32 and 34, respectively, are applied over the apertures 24 and 26 and so that the part thus created includes the same apertures defined therein. Reference is also made to the enlarged partial view of FIG. 3 and which illustrates the selected insulating patch 34 in covering fashion over a selected one of the apertures 26. As further shown in FIG. 1, a lengthened recess 36 formed in an upper surface of the die tool 10 and may correspond to the configuration of the projection 12 associated the adhering surface 14, as well as to facilitate engagement of the conveyor mechanism attachment 18.

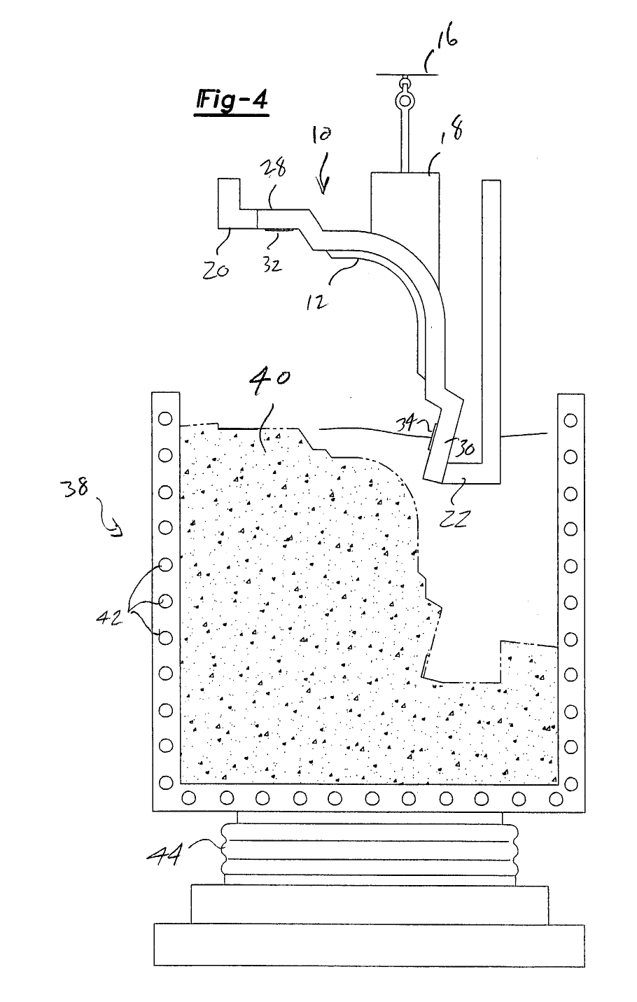

Referring now to FIG. 4, a bin is generally illustrated at 38 and which may be filled with a volume of the plasticized (blank) material in particulate form 40. The particulate material 40 is contemplated as including such as a high polymer or like synthetic material, which exhibits desired thermoplastic properties. It is also contemplated other types of polymers, polymeric based resins, and the like may also be employed within the scope of the invention and by which a desired three dimensional quantity of such material in particulate form is caused to aggregate and to adhere to the exposed and attracting surface 14 of the die tool 10. Additionally, other types of synthetic resins, such further including thermo-set resins, can be employed within the scope of the invention and in order to create the desired part from both a structural and material content perspective.

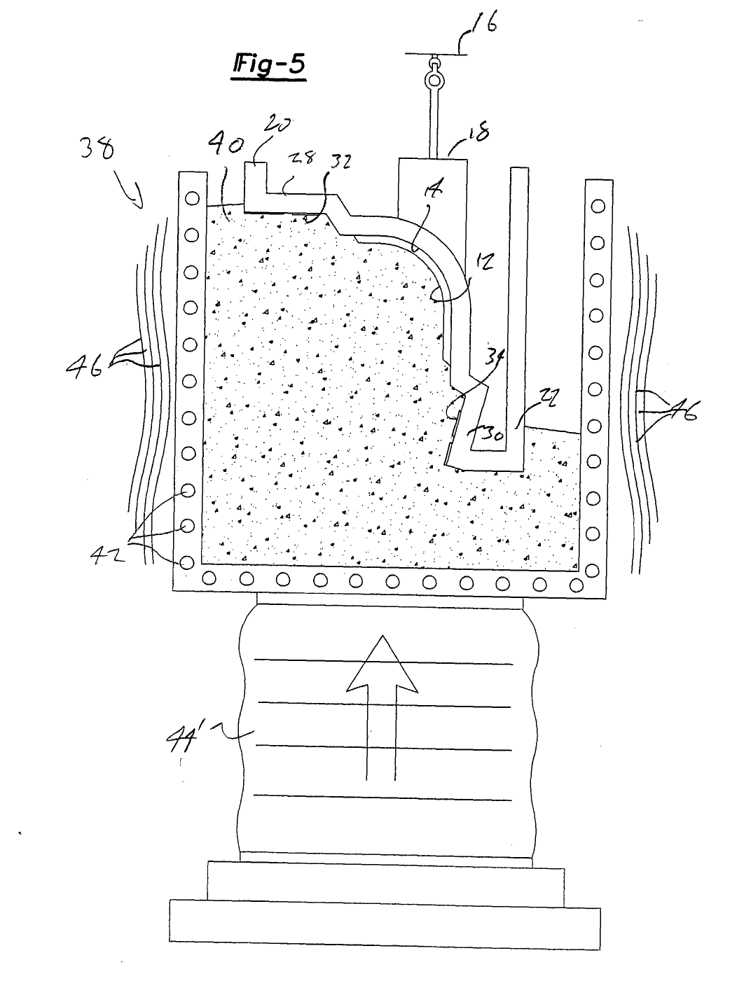

The bin 38 is illustrated in both FIGS. 4 and 5 in cutaway fashion and so that the large volume of plasticized (blank) resin 40 is illustrated held within the bin interior. Additional features of the bin 38 include the provision of a plurality of heating coils, see at 42, formed within the outer walls of the bin. The coils 42 enable preheating of the particulate volume, within a desired temperature range and which may include, without limitation, a temperature in the range of 100° F. in one preferred variant.

As is further understood that die tool 10 (with associated and particulate adhering surfaces 12 and 14) is also preheated prior to applying within the bin 38. In one preferred application, the die surfaces 12 and 14 are preheated to a temperature (such as in a range of 350° F. to 500° F.), while the ceramic surfaces 20, 22, 32, and 34, only elevate to a temperature in the range of 100° F. and corresponding generally to the preheated temperature of the particulate 40.

In order to operate in as efficient a manner as possible, it is desirous to operate the bin 38 in a successive elevating and retracting manner in combination with the advancement of successive die tools along the conveyor. In FIG. 4, the bin 38 is illustrated in its substantially lowered position, this further defined by a pedestal base 44 in a lower most retracted configuration and by which the conveyor 16 may translate (advance) a selected die tool 10 in suspended and overhanging fashion above the bin particulate 40.

The bin 38 in FIG. 5 is further illustrated in an upper most raised position (caused by the expansion of the pedestal base in the manner further illustrated at 44′ and which is understood to be caused by such as a hydraulic or pneumatic lift mechanism) and by which the die tool 10 is inserted into the bin 38 such that the exposed and adhering surface 14 is caused to be in contact with the particulate material 40. As further referenced in FIG. 5, the bin 38 may be vibrated (see vibration lines indicated at 46) and by which a specified volume of the particulate material 40 is encouraged to adhere and to form upon the polished and attracting surfaces 12 and 14 of the die tool 10 and while at the same time being dissuaded from adhering to the ceramic coating surfaces of the encircling and insulating material defining a parting line with the adhering surfaces of the die tool.

It is further understood that the desired three dimensional build-up of polymer material upon the die tool is a variable of the pre-heated temperature of the die tool, secondarily that of the particulate bin 40, and as well as the time period during which the die tool 10 is immersed within the bin 38 in contact with the particulate 40. Along these lines, parts exhibiting other thicknesses, as well as material properties, can be constructed by altering the temperatures and/or material content of the particulate bin 40 and within the scope of one skilled in the art.

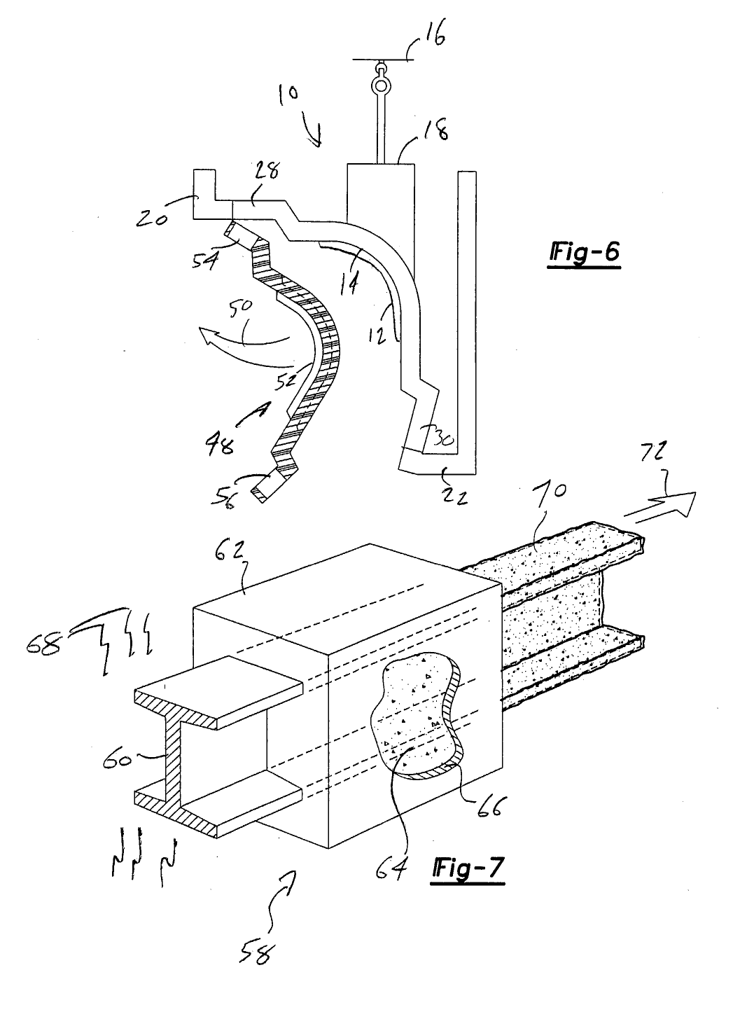

Referring to FIG. 6, the die tool 10 is illustrated in a subsequently withdrawn and advanced position by which a three dimensional part created, see generally at 48, is removed from the die tool 10. In particular, the part 48 may be peeled away (see arrow 50) or otherwise detached from the die tool surfaces 12 and 14, in a semi-fluid (green) or thermo-reacting stage and during which it is still flexible and easy to bend. As further again illustrated in FIG. 6, the part 48 thus created corresponds to the impression of the die surfaces 12 and 14 (in the illustrated example being a wheel well interior) and which exhibits at least one high quality surface corresponding to the polished facing surfaces 12 and 14 of the die tool and including a raised middle 52 (corresponding to projecting surface 12 of the die tool) as well as apertured ends 54 and 56 corresponding to the apertures previously illustrated at 24 and 26 (and associated ceramic coverings 32 and 34) formed in the die tool.

Referring to FIG. 7, a further preferred embodiment of the present invention is illustrated at 58 and by which the die tool 10 illustrated in the earlier embodiment is substituted by an elongated and structural member 60. The structural member 60 is typically an elongated steel beam, as illustrated, but which may also include such as a metal reinforcing rod or any other suitable elongated and appropriately particulate adhering construction.

The elongate structural member 60 is translated in axially extending fashion through a suitably constructed and configured bin 62 of particulate filled 64 material (see further cutaway portion defined by interior walls 66). Heat is again applied, typically to the beam, rod, etc., in the manner indicated by arrows 68 and prior to the structural member 60 being translated through the aggregate filled bin 62. A desired volume of particulate material is thereby caused to adhere to the surface of the structural member, see further at 70 and as the elongated member 60 is withdrawn from the bin 62, in the manner further illustrated by arrow 72.

In the above disclosed manner, the surface of the structural steel member is coated with a rust-inhibiting material according to a desired thickness and/or material contact based upon the input parameters (particulate composition, temperature input) of the present invention. It is also understood that the configuration of the bin 62 may be adjusted, such as by sizing apertures on opposite faces thereof, to correspond to the cross sectional outline of the elongated structural member to be passed therethrough and so that a minimal quantity of the particulate material 64 may be spilled or otherwise lost due to the effects of gravity.

Also disclosed is a method of forming a three dimensional polymer coating upon a die tool, the tool having a specified shape and size and exhibiting an exposed polymer adhering surface corresponding in configuration to a polymeric based part to be created. The method steps include filling a bin with a polymer material in particulate form, heating the die tool to a specified temperature, inserting the die tool into the bin and such that the polymer adhering surface is in contact with the particulate material, and withdrawing the die tool from the bin upon a desired volume of the polymer material adhering to the exposed surface.

Additional steps include applying a ceramic coating about an extending perimeter of the adhering surface of the tool and/or about at least one aperture defined in the die tool. Other steps again translating the die tools in succeeding fashion over the particulate filled bin, elevating the bin to immerse the die tool, vibrating the bin in the elevated position to facilitate particulate formation and adherence upon the die tool, and peeling off the semi-molten polymer material following the withdrawing of the tool from the bin.

Having described our invention, other and additional preferred embodiments will become apparent to those skilled in the art to which it pertains, and without deviating from the scope of the appended claims:

We claim:

1. An apparatus for forming a three dimensional polymer based part, comprising:
a die tool having a specified shape and size and exhibiting an exposed polymer adhering surface corresponding in configuration to a polymeric based part to be created;
a bin filled with a polymer material in particulate form; and
said die tool being inserted into said bin such that said exposed and adhering surface is in contact with said particulate material, said tool being withdrawn from said bin following a predetermined time period and by which a specified volume of polymer material is caused to adhere and to form upon said exposed surface and prior to the polymer part being removed from said die.

2. The apparatus as described in claim 1, said die tool further comprising an insulating and non-polymer adhering surface surrounding said exposed and adhering surface.

3. The apparatus as described in claim 2, said insulating surface further comprising a ceramic coating.

4. The apparatus as described in claim 3, further comprising at least one ceramic plug for securing over an aperture formed in said exposed and adhering surface.

5. The apparatus as described in claim 1, further comprising heating said exposed adhering surface of said die tool to a specified temperature prior to contacting said particulate material.

6. The apparatus as described in claim 5, further comprising heating said tool to a temperature in a range of from 300° Fahrenheit to 500° Fahrenheit.

7. The apparatus as described in claim 1, further comprising heating said polymer particulate in said bin to an elevated temperature.

8. The apparatus as described in claim 7, further comprising a plurality of heating coils formed within outer walls defining said bin and for preheating said bin filled particulate.

9. The apparatus as described in claim 1, further comprising at least one die tool suspended from a continuous conveyor.

10. The apparatus as described in claim 9, further comprising an elevator for raising said bin to encompass each of a plurality of die tools in successive fashion.

11. The apparatus as described in claim 10, further comprising vibrating said bin in said raised position to facilitate adhering of said polymer particulate upon said die tool.

12. The apparatus as described in claim 1, further comprising a specified time interval during which said die tool is in contact with said particulate material.

13. The apparatus as described in claim 12, further comprising a time interval range of between 30 seconds and 1 minute.

14. The apparatus as described in claim 1, further comprising a specified material thickness of said adhered polymer.

15. The apparatus as described in claim 14, further comprising a material thickness in a range of between 0.125″ to 0.500″.

16. An apparatus for forming a three dimensional polymer based part, comprising:
an elongated structural member having a specified cross sectional dimension and exhibiting an exposed polymer adhering surface;
a bin filled with a polymer material in particulate form; and
said structural member being translated through said bin such that said exposed and adhering surface is in contact with said particulate material, a specified volume of polymer material being caused to adhere and to form upon said exposed surface of said structural member.

17. The apparatus as described in claim 16, said elongated structural member comprising at least one of a steel beam and a reinforcing steel bar.

18. The apparatus as described in claim 16, further comprising preheating said elongated structural member prior to translating said member through said particulate filled bin.

19. The apparatus as described in claim 18, further comprising heating said elongated structural member to a temperature in a range of between 350° F. to 500° F.

20. A method for forming a three dimensional polymer based coating, comprising the steps of:
providing a die tool having a specified shape and size and exhibiting an exposed polymer adhering surface corresponding in configuration to a polymeric based part to be created;
filling a bin with a polymer material in particulate form;
heating the die tool to a specified temperature;
inserting the die tool into the bin and such that the polymer adhering surface is in contact with the particulate material; and
withdrawing the die tool from the bin upon a desired volume of the polymer material adhering to the exposed surface.

21. The method as described in claim 20, further comprising the step of applying a ceramic coating about an extending perimeter of the adhering surface of the die tool.

22. The method as described in claim 21, further comprising the step of applying a ceramic plug about at least one aperture formed in the die tool.

23. The method as described in claim 22, further comprising the step of suspending the die tool from an overhead conveyor.

24. The method as described in claim 23, further comprising the step of elevating the bin to encompass the die tool.

25. The method as described in claim 24, further comprising the step of vibrating the bin in the elevated position to facilitate adhering of the polymer particulate upon the die tool.

26. The method as described in claim 20, further comprising the step of adhering the polymer particulate upon the die tool to a thickness in a range of between 0.125″ to 0.500″.

27. The method as described in claim 20, further comprising the step of peeling the built up polymer material from the die tool.
